(19) United States
(12) Patent Application Publication
(10) Pub. No.: US 2013/0155322 A1
(43) Pub. Date: Jun. 20, 2013

(54) DISPLAY DEVICE, DISPLAY METHOD, TRANSMITTING DEVICE AND TRANSMITTING METHOD

(71) Applicant: Sony Corporation, Tokyo (JP)

(72) Inventors: Takahiro Goto, Kanagawa (JP); Takuro Shoji, Kanagawa (JP)

(73) Assignee: Sony Corporation, Tokyo (JP)

(21) Appl. No.: 13/706,596

(22) Filed: Dec. 6, 2012

(30) Foreign Application Priority Data
Dec. 14, 2011 (JP) 2011-273665

(51) Int. Cl. H04N 5/445

(52) U.S. Cl. CPC H04N 5/445
USPC 348/563

(57) ABSTRACT

Provided a display device including a receiving unit that receives image data of a predetermined format for each frame; an additional information detection unit that detects an additional information disposed in a specific position of the image data of one frame received by the receiving unit; a synthesis unit that extracts division images of a still image disposed in the image data of one frame received by the receiving unit, synthesizes the extracted division images based on the additional information and assembles the still image greater than the number of pixels of the image data of one frame; and a display unit that displays the still image synthesized by the synthesis unit.

### BACKGROUND

The present disclosure relates to a display device and a display method for receiving and displaying image data of a still image and a transmitting device and a transmitting method for transmitting the image data of the still image.

### SUMMARY

Recently, in a display device for receiving and displaying image data, a high definition of a display image has been developed. In the related art, an image data format having high definition generally is referred to as an HD (High Definition) format in which the number of pixels for one frame is 1920 horizontal pixels×1080 vertical pixels. In contrast, recently, a standard in which the number of pixels for one frame is 4096 horizontal pixels×2160 vertical pixels, that is, which is called 4K format of about 4 times the HD standard, has been suggested and an image device corresponding to the standard has been developed. The number of pixels of the HD format or the 4K format is one example and there may be cases where the number of pixels is different from the number described above. In addition, even in a name of the format, the HD format or the 4K format may be called different names.

In this specification, in a case where the image data format is called the HD format, one frame indicates the image data of 4096 horizontal pixels×2160 vertical pixels and in a case where the image data format is called the 4K format, one frame indicates the image data of 4096 horizontal pixels×2160 vertical pixels.

In the image data of the 4K formats, since the number of the pixels for one frame is very large, it is necessary to increase a transmission rate significantly so as to transmit non-compressed image data in real time and thus it is necessary to apply an advanced technology for realizing a real time transmission.

Japanese Unexamined Patent Application Publication No. 2004-120499 discloses a technology for connecting a transmitting side and a receiving side to each other with a plurality of transmission channels in order to transmit the image data having the number of pixels exceeding the HD format.

In addition, the technology disclosed in Japanese Unexamined Patent Application Publication No. 2004-120499 divides the image data into a plurality of systems on the transmitting side and transmits each of the divided image data using a separate transmission channel at the same time. It is possible to suppress the transmission rate of one transmission channels to be low corresponding to the number of divisions by transmitting the data using a plurality of transmission channel and to transmit image data having the larger number of pixels of one frame relatively easily.

### SUMMARY

As described above, it is necessary to apply the advanced technology such as an increase in speed of a transmission rate in order to transmit the image of the 4K format in real time as it is and thus it is necessary to have a configuration which performs a complicated transmission at a high price in both the transmitting side device and the receiving side device. Therefore, both a display device capable of transmitting the image data and a display device capable of receiving the image data in the 4K format are only an extraordinarily limited number of devices at present.

Meantime, devices capable of handling the image of high definition corresponding to the 4K format are becoming available. For example, as a digital still camera capable of photographing a still image, a digital still camera which can photograph the image having the number of pixels of a high definition corresponding to the 4K format has already become available. Generally, the digital still camera records the photographed image data to a memory card and replaces the recorded memory card with other devices to transmit the data to other devices. In addition, the digital still camera body and other devices (a personal computer or the like) are directly connected to each other with a USB cable to transmit the image data to other devices over time at a relatively low transmission rate. A process of transmitting the image data of a high definition to other devices is a process that takes time and effort.

It is desirable to provide a transmitting device and a transmitting method capable of transmitting a still image of high definition and a display device and a display method capable of receiving and displaying the still image of high definition with a simple configuration using an existing transmission standard.

According to an embodiment of the present disclosure, there is provided a display device including: a receiving unit that receives image data of a predetermined format for each frame; an additional information detection unit that detects an additional information disposed in a specific position of the image data of one frame received by the receiving unit; a synthesis unit that extracts division images of a still image disposed in the image data of one frame received by the receiving unit, synthesizes the extracted division images based on the additional information and assembles the still image greater than the number of pixels of the image data of one frame; and a display unit that displays the still image synthesized by the synthesis unit.

According to another embodiment of the present disclosure, there is provided a display method including: receiving image data of a predetermined format for each frame; detecting an additional information disposed in a specific position of the image data of one frame received in the receiving of the image data; extracting division image of a still image disposed in the image data of one frame received in the receiving of the image data, synthesizing the extracted division images based on the additional information and assembling the still image greater than the number of pixels of the image data of one frame; and displaying the still image synthesized in extracting of the division images.

According to still another embodiment of the present disclosure, there is provided a transmitting device including: a division processing unit that obtains data of a plurality of division images by dividing the image data of one still image for each predetermined area and disposing each of the obtained data of the plurality of division images in image data of a predetermined format having the number of pixels less than that of the still image; an information addition unit that disposes additional information on division images in a specific position within the image data of the predetermined format obtained in the division processing unit; and a transmitting unit that outputs whole produced frames while the additional information unit repeatedly outputs frames in which the additional information is disposed multiple times for each division image.

According to still another embodiment of the present disclosure, there is provided a transmitting method including: obtaining data of a plurality of division images by dividing the image data of one still image for each predetermined area and disposing each of the obtained data of the plurality of division images in image data of a predetermined format having the number of pixels less than that of the still image; disposing additional information on the division images in a specific position within the image data of the predetermined format obtained in the division and processing the image data; and outputting whole produced frames while the disposing additional information repeatedly outputs frames in which the additional information is disposed multiple times for each division image.

According to the present disclosure, an image data of the format can transmit a still image of a large pixel number exceeding the number of pixels included in one frame over a plurality of frames by using the imaging data of a predetermined format.

According to the present disclosure, since the image data of one frame which the image number is large is divided into a plurality of the image data, and each division image data is repeatedly transmitted multi times, a process which restores to the image data of one frame of an original pixel number by receiving the division image data is surely and easily performed. Therefore, it is possible to gradually transmit and display the still image data in which the pixel number is large and a slide show display transmitting and displaying the still image data having a high definition in which the pixel number is large can be easily achieved.

### BRIEF DESCRIPTION OF THE DRAWINGS

FIG. 1 is a configuration view illustrating an example of a system according to an embodiment of the present disclosure.

FIG. 2 is a block diagram illustrating a configuration example of a contents reproduction device according to an embodiment of the present disclosure.

FIG. 3 is a block diagram of a configuration example of a projector device according to an embodiment of the present disclosure.

FIG. 4 is a view illustrating a division example of an image according to an embodiment of the present disclosure.

FIGS. 5A to 5C illustrate an example of a division image and additional information of the division image according to an embodiment of the present disclosure.

FIG. 6 is a view illustrating an example of a transmission state of a division image according to an embodiment of the present disclosure.

FIG. 7 is a view illustrating a transition of a transmitting process of a transmitting side and a receiving side according to an embodiment of the present disclosure.

FIGS. 8A to 8E are timing diagrams illustrating an example of process timing in a receiving side according to an embodiment of the present disclosure.

FIGS. 9A to 9D are sequence diagrams (1 thereof) illustrating a detailed example of a receiving process according to an embodiment of the present disclosure.

FIGS. 10A to 10D are sequence diagrams (2 thereof) illustrating a detailed example of a receiving process according to an embodiment of the present disclosure.

### DETAILED DESCRIPTION OF EMBODIMENTS

An example of an embodiment of the present disclosure (hereinafter, referred to as an example) will be described in a following sequence.

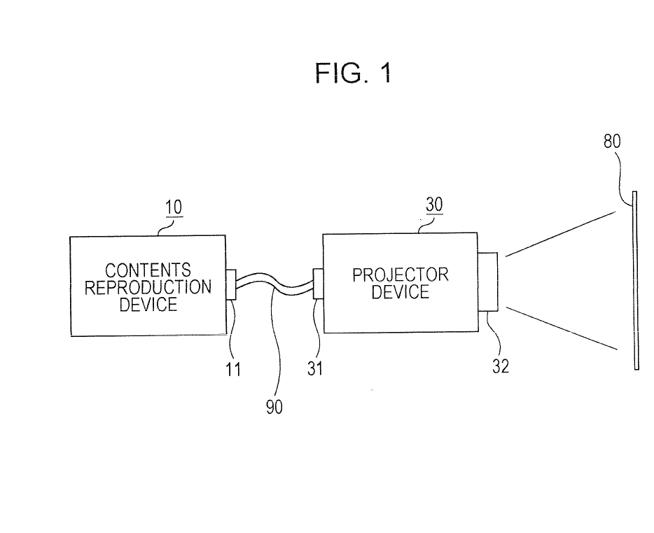

### 1. Configuration Example of Whole System (FIG. 1)

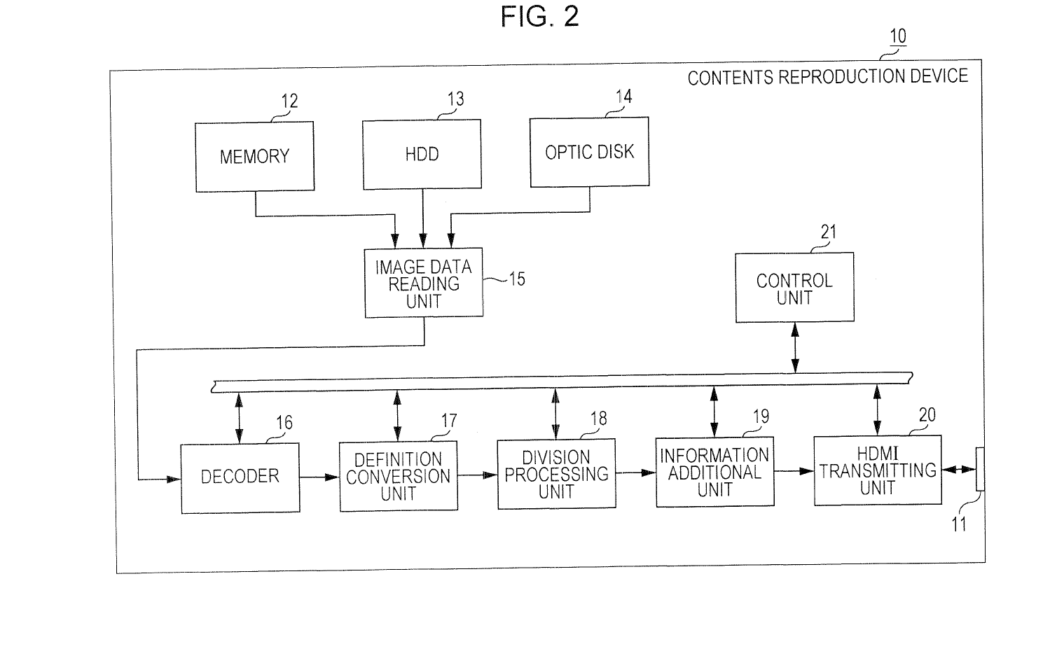

### 2. Configuration Example of Transmitting Device (FIG. 2)

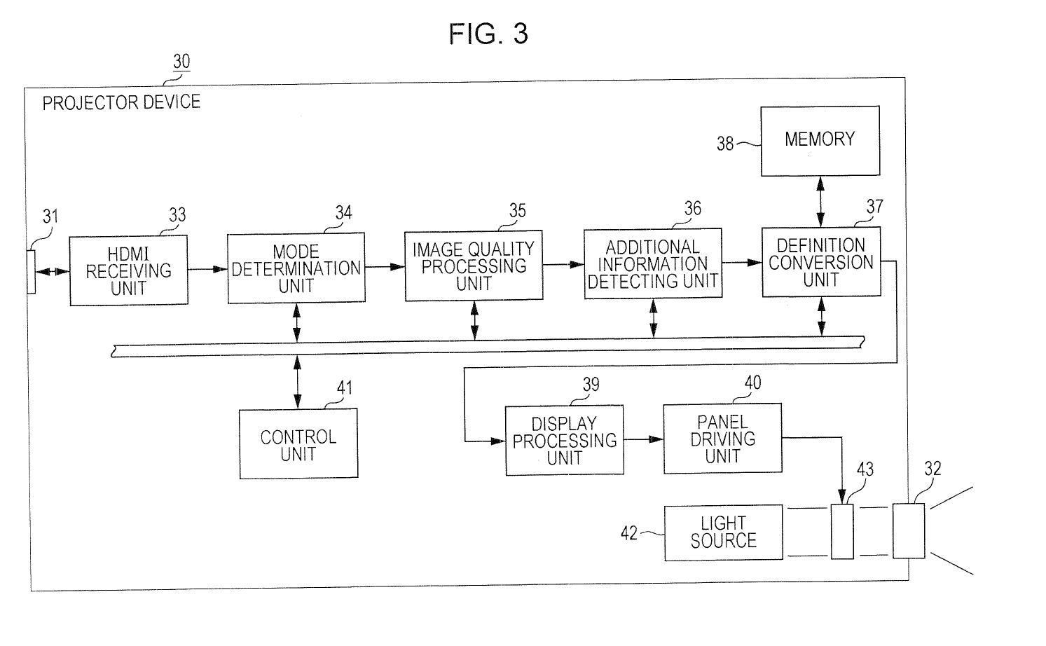

### 3. Configuration Example of Display Device (FIG. 3)

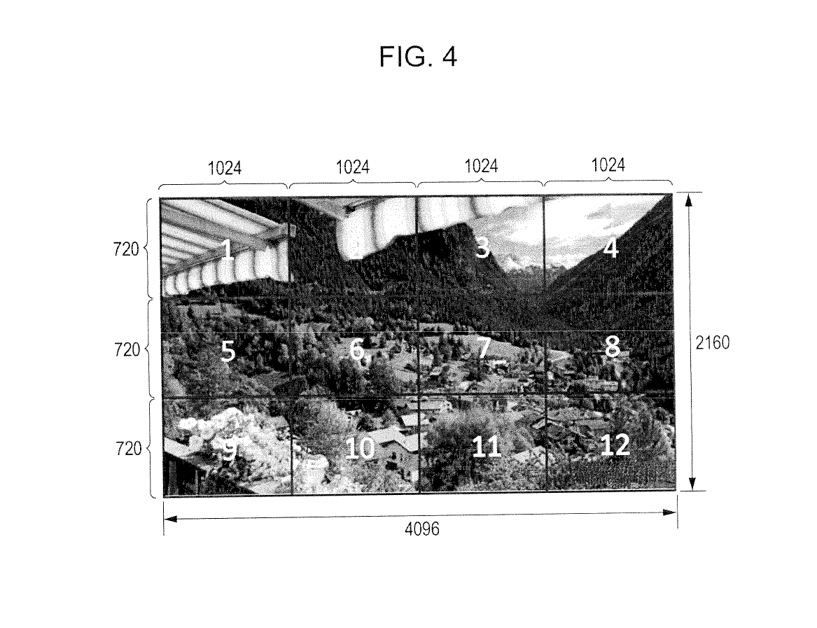

### 4. Detailed Example of Transmitting Image (FIGS. 4, 5 and 6)

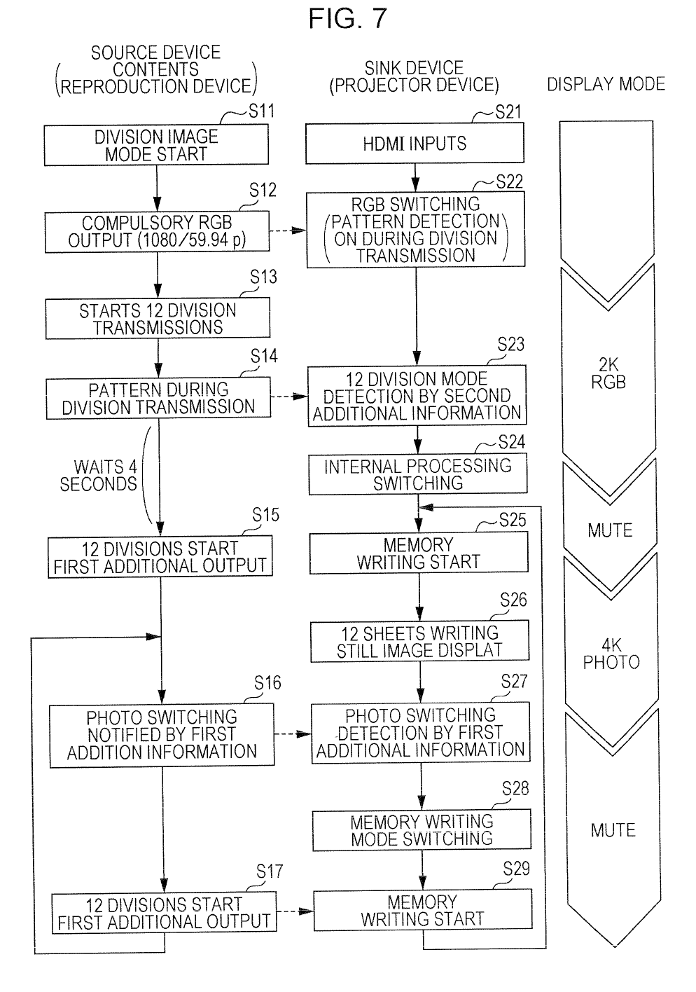

### 5. Example of Transmitting Process (FIG. 7)

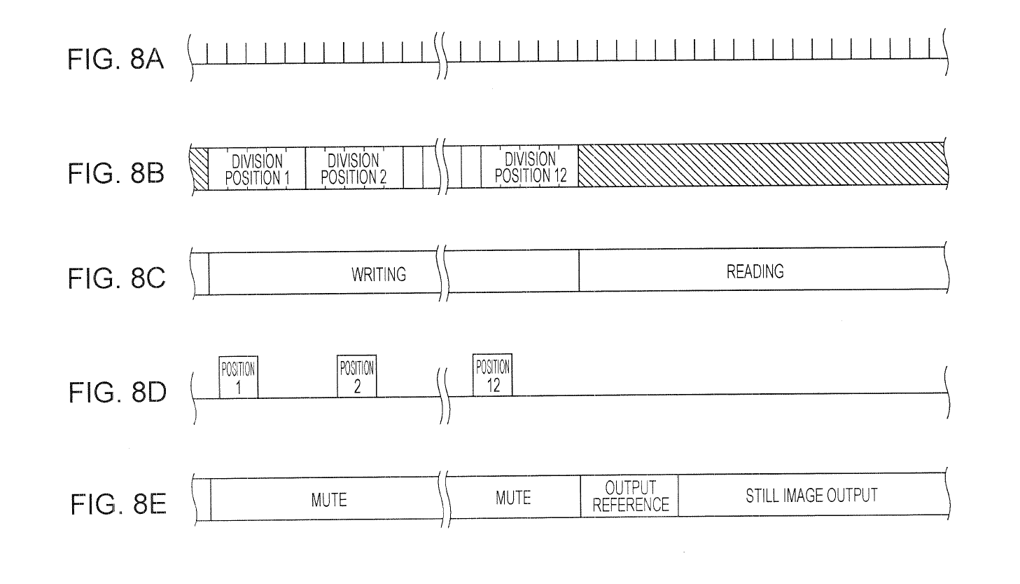

### 6. Example of Receiving Process in Display Device (FIGS. 8, 9 and 10)

### 7. Modification Example

### 1. Configuration Example of Whole System

First, the configuration of a whole system will be described with reference to FIG. 1.

As illustrated in FIG. 1, an HDMI terminal 11 of a contents reproduction device 10 and an HDMI terminal 31 of a projector device 30 are connected to each other by the transmission cable 90. The HDMI terminals 11 and 31 are terminals conforming to an interface standard for a digital image transmission called a HDMI (High-Definition Multimedia Interface) standard. When a digital image data is transmitted according to the HDMI standard, a control data and the like is transmitted in bidirectional while the digital image data is transmitted from a transmitting device (source device) to a receiving device (sink device). In addition, in the HDMI standard, each pixel value included in the image data is transmitted without compression as it is. For example, in the image data of one frame, pixel values (digital value) of three primary colors of red R, green G and blue B of all pixels composed of the one frame are transmitted.

The contents reproduction device 10 reproduces the accumulated image data and the reproduced image data is transmitted from the HDMI terminal 11 to the transmission cable 90. The projector device 30 displays and processes the image data received by the HDMI terminal 31 via the transmission cable 90. In addition, the projector device 30 projects the image from a projector lens 32 to the screen 80.

Herein, the contents reproduction device 10 has an ability to transmit the image data as a moving image wherein the contents reproduction device reproduces the HD format, that is, the image data of the number of 1920 horizontal pixels×the number of 1080 vertical pixels to have an ability to transmit the data from the HDMI terminal 11.

In addition, the projector device 30 has similarly an ability to receive the image data of the moving image of 1920 horizontal pixels×1080 vertical pixels to the HDMI terminal 31 and to display the image data. However, these capabilities are a minimum capacity and the HDMI terminal 31, for example, may also have an ability to receive the image data of a 4K format.

In addition, the contents reproduction device 10 and the projector device 30 apply the technology of the present disclosure described below and thus the number of pixels of one frame can handle the image data of the still image of the 4K format of the number of 4096 horizontal pixels×the number of 2160 vertical pixels. That is, the contents reproduction device 10 divides the image data of the still image of the 4K format into a plurality of frames as described below to transmit the data from the HDMI terminal 11.

When the image data of the still image of the 4K format is divided into the plurality of frames and the data is input to the HDMI terminal 31, the projector device 30 synthesizes the still image of a definition of the 4K format to perform a display process.

### 2. Configuration Example of Transmitting Device

Next, a configuration of contents reproduction device 10 which is a transmitting device of an image data will be described with reference to FIG. 2.

The contents reproduction device 10 can be applied to various image devices, which is capable of transmitting the image data to the outside by providing a HDMI terminal, such as a video game device or a digital still camera and the like.

The contents reproduction device 10 is a storage unit in which the image data is stored and includes a memory 12. In addition, the contents reproduction device 10 includes a hard disk drive 13 and an optical disk driving unit 14, and image data read from a medium (a hard disk or an optical disk) can be obtained in the hard disk drive 13 and the optical disk driving unit 14.

The image data read from the memory 12 and the like is supplied to an image data reading unit 15. The image data reading unit 15 has a case where the image data of the moving image is read to be supplied and a case where the image data of the still image is read to be supplied. In a description below, the case where the image data of the still image is read will be described and a description regarding a processing of the moving image is omitted.

Herein, the image data of the still image which the image data reading unit 15 reads from the memory 12 and the like is the image data of the 4K format of the number of 4096 horizontal pixels×the number of 2160 vertical pixels.

Therefore, the image data of one frame of the 4K format read by the image data reading unit 15 is supplied to a decoder 16. The decoder 16 decodes the supplied image data and converts the decoded data into the image data of one frame having pixels without compression. The decoder 16, for example, performs a decoding of a JPEG (Joint Photographic Experts Group) scheme. Therefore, the decoder 16 supplies the image data of the decoded one frame to a definition conversion unit 17.

When the number of pixels of one frame of the supplied image data is not a prescribed pixel number such as the 4K format, the definition conversion unit 17 converts the image data to be the 4K format. Therefore, when an input data is the 4K format, the definition conversion unit 17 does not perform a conversion process.

Then, the image data of one frame of the 4K format obtained in the definition conversion unit 17 is supplied to a division processing unit 18. The division processing unit 18 divides the image data of the supplied one frame into image data of 12 regions. A detailed description of a division process will be described below. However, the image data having the number of pixels for one frame, that is, of the number of 4096 horizontal pixels×the number of 2160 vertical pixels is divided into 12 image data. Each image data divided has the number of 1024 horizontal pixels×the number of 720 vertical pixels. In described below, an image data after being divided is referred to as a division image data.

Furthermore, the division processing unit 18 disposes each division image data in one frame of the HD format of the number of 1920 horizontal pixels×the number of 1080 vertical pixels. Therefore, the division processing unit 18 outputs the image data of the HD format in which each division image data is disposed for each frame in sequence. In this case, the division processing unit 18 performs a process which continuously outputs five times the image data of the HD format in which the division image data of the same division area is disposed. Therefore, since each division image data divided into 12 areas is continuously output 5 times, an output of the image of one frame of 4K format is completed in a sum of 60 frames of 12 divisions×5 times.

The image data of an HD format output by the division processing unit 18 is supplied to an information addition unit 19. The information addition unit 19 adds mode information for distinguishing a situation where the division image data is disposed and additional information according to information such as positions of 12 divisions described above to a position determined for each information. Though details of the additional information is described below, both first additional information D1 and second additional information D2 are added to the information addition unit 19.

Then, the image data in which the additional information is disposed in the information addition unit 19 is supplied to an HDMI transmitting unit 20. The HDMI transmitting unit 20 performs a transmitting process for transmitting the image data from a HDMI terminal 11 and the processed image data is supplied to the HDMI terminal 11.

In addition, the contents reproduction device 10 includes a control unit 21 that controls an operation of each unit in the contents reproduction device 10. The control unit 21 performs an instruction of an operation mode with respect to the decoder 16, the definition conversion unit 17, the division processing unit 18 and the information addition unit 19. For example, when the process of the division image data described above is performed, the control unit 21 instructs a corresponding operation mode.

### 3. Configuration Example of Display Device

Next, a configuration of the projector device 30 which is the display device receiving and displaying the image data will be described with reference to FIG. 3.

The projector device 30 includes a HDMI receiving unit 33 that receives and processes the image data obtained in the HDMI terminal 31. Though the HDMI receiving unit 33 can receive the image data of various formats by instructions of the operation mode from the control unit 41, it is assumed that a mode receiving the image data of the HD format is in the middle of setting.

The image data of the HD format received by the HDMI receiving unit 33 via the HDMI terminal 31 is supplied to a mode determination unit 34. The mode determination unit 34 determines the image data in which the division image data is disposed from the pixel value of a specific pixel position in the supplied image data and supplies the determination result to a control unit 41. The mode determination unit 34 determines second additional information D2 within a first additional information D1 and the second additional information D2 as described below.

In order to determine the additional information from the image data of the whole frames received by the HDMI receiving unit 33 at regular interval such as 60 frames per second at high speed, the mode determination unit 34 detects only pixel value of one pixel of the specific position for each frame. In addition, the mode determination unit 34 shifts a position of the detected pixel by one frame.

In addition, the image data of the HD format is output by the mode determination unit 34 and is supplied to an image quality processing unit 35. When an input image data is the image data of the moving image, the image quality processing unit 35 performs a process for performing a high image quality. In addition, in a mode where the division image data into which divides one frame of the 4K format is supplied, the mode determination unit 34 outputs each pixel data included in the image data as the pixel data of a value as it is without a processing for a high image quality. The operation mode of the image quality processing unit 35 is set by the instruction from the control unit 41.

The image data processed by the image quality processing unit 35 is supplied to an additional information detection unit 36. The additional information detection unit 36 detects additional information added to the image data of one frame and writes the detected additional information onto a resister in the additional information detection unit 36. The Information written into the resister is read by the control unit 41 whenever necessary and the control unit 41 detects a variation of the additional information.

In addition, the image data output by the additional information detection unit 36 is supplied to the definition conversion unit 37. When the image data of the moving image of the HD format is supplied, the definition conversion unit 37 is a processing unit that performs definition conversion from the image data of the HD format into the image data of the 4K format and a memory 38 for performing the definition conversion is connected to the definition conversion unit 37.

Herein, in a mode where the division image data into which divides one frame of the 4K format is supplied, the definition conversion unit 37 and the memory 38 are used as a synthesis unit. That is, the definition conversion unit 37 successively writes the divided image data supplied from the additional information detection unit 36 onto the memory 38 and performs a synthesis process which restores to the image data of one frame of the 4K format. The operation mode of the definition conversion unit 37 is set by the instructions from the control unit 41.

In addition, the image data of the 4K format obtained in the definition conversion unit 37 is supplied to a display processing unit 39. The display processing unit 39 performs a processing necessary for displaying the image. In addition, the image data processed in the display processing unit 39 is supplied to a panel driving unit 40 from the display processing unit 39. The panel driving unit 40 performs a process which drives the display in the display panel 43 based on the image data supplied from the display processing unit 39.

A display panel 43 is disposed in a position at which a light from a light source 42 is transmitted or reflected. In addition, the light which transmits and reflects the display panel 43 becomes an image light corresponding to a display image. The image light obtained in the display panel 43 is incident on a projector lens 32 and is projected into the screen 80 (FIG. 1) from the projector lens 32 and the image light is displayed on the screen 80.

### 4. Detailed Example of Transmitting Image

Next, a process which transmits the image data of the still image of one frame of the 4K format as the division image will be described.

FIG. 4 is a view illustrating a state where the images of one frame of the 4K format of the number of 4096 horizontal pixels×the number of 2160 vertical pixels are divided into 12 images.

In this example, the images of the still image of one frame of the 4K format are divided into four images in a horizontal direction and into three images in a vertical direction and thus the division image of the number of 1024 horizontal pixel×720 vertical pixels from the image of one frame obtains 12. A number for the division position from 1 to 12 is granted in the image of each division position. In an example in FIG. 4, it is assumed that an upper-left is a division position 1, a horizontal position is divisions 2, 3 and 4, and a lower-right is a division position 12.

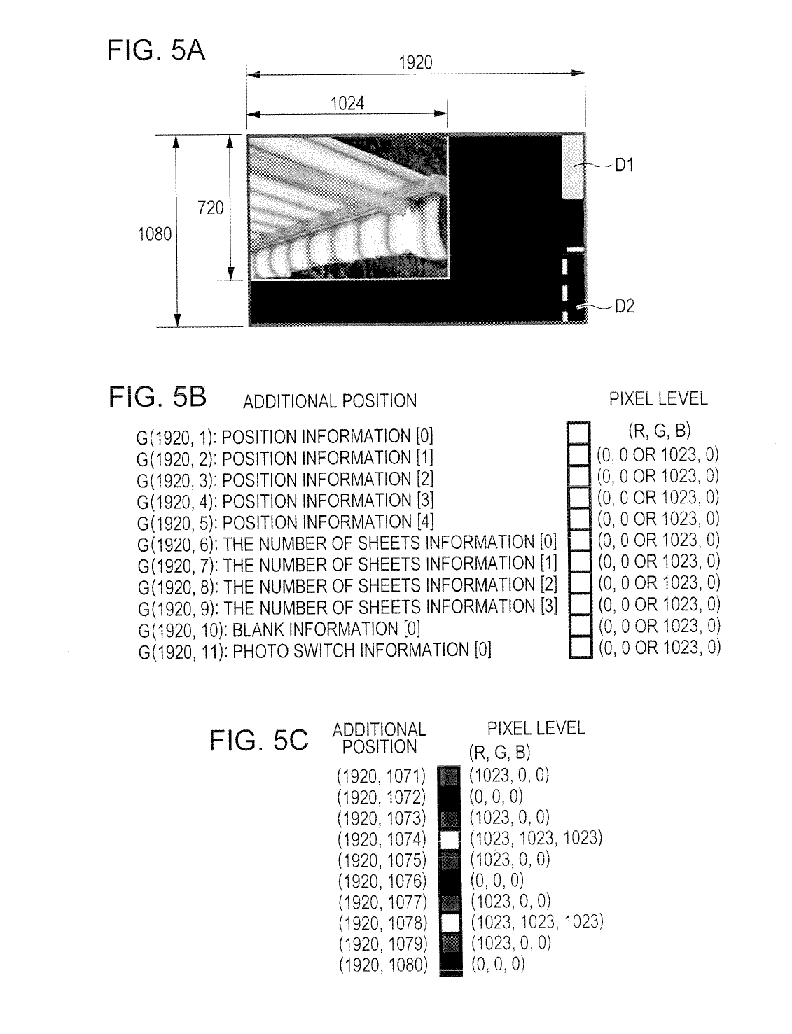

In addition, as illustrated in FIG. 5A, each pixel of the number of 1024 horizontal pixels×the number of 720 vertical pixels is disposed in a portion of the pixel of the image data of one frame of the HD format. That is, as illustrated in FIG. 5, the image data of one frame of the HD format is the number of 1920 horizontal pixels×the number of 1080 vertical pixels and the division image of the number of 1024 horizontal×the number of 720 vertical pixels is disposed using an area of the upper-left one frame of the HD format. In addition, a space area in which the division image is not disposed is used and first additional information D1 and second additional information D2 is disposed in the space area. As described later, the first additional information D1 and the second additional information D2 are additional information added by using only one pixel of the right end in each horizontal line. However, additional position is highlighted so as to easily distinguish the additional positions in FIG. 5.

As illustrated in FIG. 5B, 11 pixels are used from top of the right end of one frame, so that the information of 11 bits in total is added to the first additional information D1 by embodying the information by one bit information in one pixel.

When the data is embodied in this position, a value of G data (a green pixel data) within the data of 3 channels of R, G and B included in one pixel is set as 0 or 1023 and values of R data and B data are set as 0. That is, the value R, G and B become either [0.0,0] or [0,1023,0].

In FIG. 5B, additional positions G(1920,1) to G(1920,11) shows using the vertical pixel image positions 1 dot to 11 dots (that is, one line to 11 lines) at the horizontal pixel position 1920 dot (that is, a right end).

As illustrated in FIG. 5B, information of 11 bit included in the first additional information D1 shows the following contents from top to bottom.

Bit of position information [0]

Bit of position information [1]

Bit of position information [2]

Bit of position information [3]

Bit of position information [4]

Bit of the number of sheet information [0]

Bit of the number of sheet information [1]

μBit of the number of sheet information [2]

Bit of the number of sheet of information [3]

Bit of flag information [0]

Bit of photo switch information [0]

5 bits of the position information [0] to [4] show the image of a certain division position within the division position divided into 12 areas. When the image of the same division area is repeatedly transmitted for each 5 frames, 4 bits of sheet information [0] to [4] show a first to a fifth discrimination. One bit of a blank information [0] shows information of instruction setting as a blank image (black image) selecting a display as a black image. A bit of a photo switching flag [0] shows that the still image of one frame of the 4K format is switched and the value is inverted every time a group of the still image to be output is switched.

The second additional information D2 shows a transmission mode for distinguishing a disposition of the division image data. That is, as illustrated in FIG. 5C, the second additional information D2 is information added such that each 10 pixels from the bottom from the right end of one frame becomes the determined pixel value. The data of the transmission mode as the second additional information D2 causes 10 pixels to become the same value during a transmission of the division image data. 10 pixels of the data of the transmission as the second additional information become the same value during a transmission of the division image data.

In addition, if the mode determination unit 34 of the projector device 30 illustrated in FIG. 3 determines only one pixel of 10 pixels included in the second additional information D2, the determination is a process in which a value of only one pixel in 10 pixels included in the second additional information D2 is determined.

For example, in one frame, when the pixel of a first pixel value from the top in 10 pixels is [1023,0,0] as the R, G and B values as illustrated in FIG. 5C, the mode determination unit 34 determines as frames in which the division data is disposed.

In addition, in the next frame, when a pixel value of a second pixel from the top in 10 pixels is [0,0,0] as the values of R, G and B as illustrated in FIG. 5C, the mode determination unit 34 determines to be frames in which the division image data is disposed.

In each pixel position, when each pixel value is detected to be a value other than an image value illustrated in FIG. 5C, the mode determination unit 34 determines not to be a transmission mode in which the division image data is disposed.

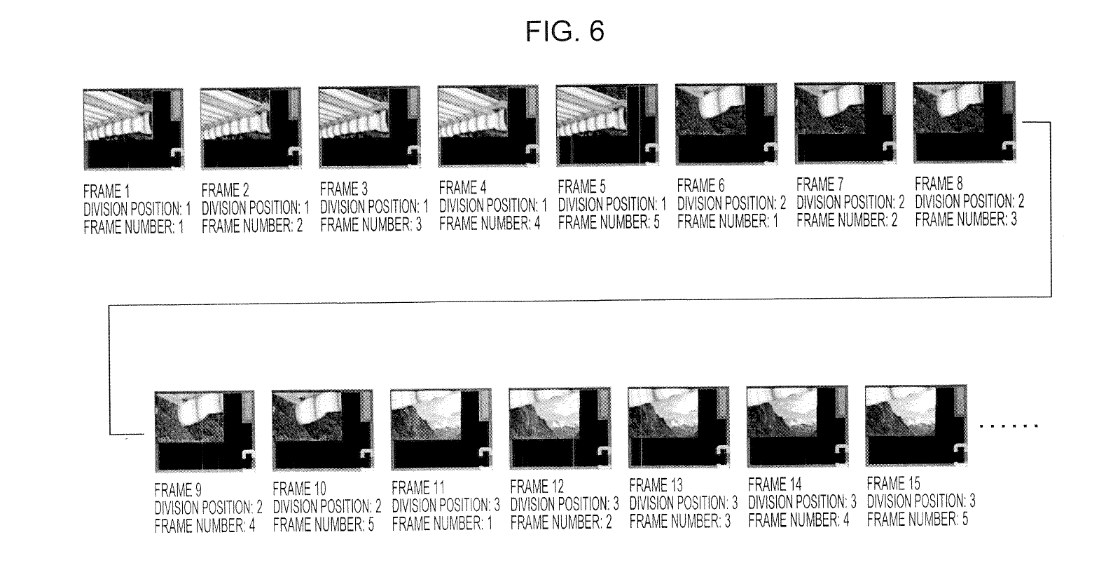

FIG. 6 is a view illustrating a transmission example of a frame in which the division image data is disposed.

FIG. 6 illustrates a first frame to 15th frame of a group of the division image. For example, in the first frame, the division position 1 and a frame number 1 are indicated in the first additional information D1. In a second frame 2, a division position 1 and a frame number 2 are indicated in the first additional information D1. Therefore, the division image has the same division position 1 until fifth frames and only frame number is changed. The image of the same contents of the division position 1 is repeatedly disposed from the first frame to the fifth frame even with respect to the disposed dividing image.

In a sixth frame, a division position 2 and the frame number 1 is indicated in the first additional information D1 and the contents of the disposed division image also is set as an image of contents of the division position 2. In addition, in a seventh frame, a division position 2 and a frame number 2 are indicated in the first additional information D1 and only frame number is changed until a tenth frame. The image of the same contents of the division position 2 is repeatedly disposed from the sixth frame to the tenth frame even with respect to the disposed division image.

Accordingly, since the position of the division image is changed for each 5 frames and the division image is divided into 12 from the division position 1 to the division position 12, a transmission of the image data of the still image of one frame (one sheet) of the 4K format illustrated in FIG. 4 is completed at the sum of 60 frames of 5 frames×12 divisions.

### 5. Example of Transmission Processing

Next, a process that transmits the image data of the still image of the 4K format between the contents reproduction device 10 (a source device) that is a device of the transmitting side and the projector device 30 (a sink device) that is a device of the receiving side will be described with reference to a sequence view of FIG. 7. A process in the transmitting side illustrated in FIG. 7 and a process in the receiving side are each independently performed. That is, an exchange of information on a mode in which transmits the dividing image of the still image via the transmission cable 901 is not performed between the contents reproduction device 10 and the projector device 30. Herein, preferably, the information on the mode in which transmits the division image of the still image is transmitted from the contents reproduction device 10 to the projector device 30 via the transmission cable 90.

First, the contents reproduction device 10 starts the division image mode (step S11). The projector device 30 is set to the image input mode which selects the HDMI terminal 31 (step S21). The setting of these modes, for example, is performed by an operation of a user who watches.

In the contents reproduction device 10, if the division image mode starts, 1080/59.94p mode that is the image data of the HD format is set as an output mode of the HDMI transmitting unit 20 and the RGB mode is set as the mode of the pixels (step S12). 1080/59.94p mode is a mode in which a frame frequency is 59.94 Hz at the number of 1080 lines for one frame. The RGB mode is a mode in which the pixels are transmitted with values of the red R, the green G and the blue B.

In the projector device 30, the HDMI receiving unit 33 detects the setting of the mode of step S12 in a transmitting side to start the reception in the corresponding mode (step S22). In this case, the HDMI receiving unit 33 starts a reception in 1080/59.94p mode and thus the image display mode in the projector device 30 becomes the mode of the HD format. That is, the image of the number of the 1920 horizontal pixels×the number of the 1080 vertical pixels becomes a mode displaying at 59.94 Hz. However, there is a case where the number of actual display pixels may be different from the number of the 1920 horizontal pixels×the number of the 1080 vertical pixels by the conversion in the definition conversion unit 37. In addition, if the setting of the mode is performed in the step S22, the mode determination in the mode determination unit 34 starts by the instruction from the control unit 41.

Next, the transmission process of the division image starts in the contents reproduction device 10 (step S13) and the division image mode is instructed in the second additional information D2 added to the image of each frame (step S14). The second additional information D2 is determined in the mode determination unit 34 of the projector device 30 (step S23). The mode determination unit 34 determines the division image mode and thus the control unit 41 of the projector device 30 performs a processing switching the image display mode to a mode in which is displayed by synthesizing the division image of the still image (step S24). The projector device 30 becomes a mode displaying the image of the still image of the 4K format by switching the display mode. In a mode displaying the image of the still image of the 4K format, the image quality process in the image quality processing unit 35 is stopped by controlling the control unit 41. That is, the image quality processing unit 35 outputs the image value of each frame input to the image quality processing unit 35 as an image value as it is. In addition, during the switching process, the flag indication is instructed in the blank information of the first additional information D1 and the image mute process setting the display image as a blank image is performed by controlling the control unit 41.

In addition, the contents reproduction device 10 waits 4 seconds from the start of an addition of the second additional information D2 in step S14 and after a standby of 4 seconds, the transmission of the division image by the 60 frames illustrated in FIG. 6 is started (step S15). Since the standby of 4 seconds is performed, the time performing the mode switching in step S24 in the projector device 30 side is secured. The 4 seconds are an example. Other time is preferable.

In addition, the addition of the first additional information D1 is started in the additional information detection unit 36 of the contents reproduction device 10 at the time of the transmission start of the division image in step S15.

In the projector device 30, the first additional information D1 is detected in the control unit 41 and thus a timing at which the transmission of the division image is started is detected and writing to the memory 38 of the division image is started (step S25). After that, every time a change of the division image is detected in the first additional information D1, the changed division image is written in the memory 38 by the control unit 41. In addition, in a step in which the division image of all 12 sheets is written in the memory 38, the control unit 41 is changed to a mode in which the memory 38 is read, releases an image mute process and starts the output of the image of the 4K format of the one frame (step S26). The display of the still image of the 4K format for the one frame is started at the time of the output start of the image of the 4K format of one frame. Herein since the image display is the still image display, the same image is repeatedly displayed for each frame.

In addition, when the contents reproduction device 10 becomes timing switching to the display of the image of a sheet of next still image, the switching is notified to the photo switching flag of the first additional information D1 and at the same time the blank display is notified to the blank information (step S16).

When a change of the photo switching flag and the flag information of the first additional information D1 is detected in the additional information detection unit 36 of the projector device 30, the image mute process is started (step S27) by the control unit 41. In addition, the control unit 41 changes the memory 38 from the reading mode to the writing mode (step S28).

In addition, the transmission of the division image by 60 frame periods illustrated in FIG. 6 is started in the contents reproduction device 10 (step S17).

In the projector device 30, the timing at which the transmission of the next division image from the first additional information D1 is started is detected and the write to the memory 38 of the division image is started in the control unit 41 (step S29). After this, every time the change of the division image is detected in the first additional information D1, the control unit 41 writes the changed division image onto the memory 38 and returns to step S26. In the step S26, at step in which the division image of all 12 sheets is written in the memory 38, the control unit 41 releases the image mute process and the process which starts the output of the image of the 4 k format of one frame is performed.

After this, in the contents reproduction device 10, if the transmission over 60 frames period of the division image in the step S17, a switching notification in the step S16 is performed repeatedly in a constant period. In the projector device 30, a process of steps S26 to S29 are repeatedly performed and the image mute process during the division image transmission and the still image display after completion of the division transmission are repeatedly performed. Therefore, a display form in the projector device 30 becomes so-called slide show indication which the still image indicated at the constant interval is changed. Since a period is which the image mute process is performed is a period adding the number of the frames providing the image synthesis in 60 frame periods which the division image is transmitted, the period is approximately one second when for example, the frame frequency is 59.94 Hz.

### 6. Example of Receiving Process in Display Device

Next, a processing timing of the projector device 30 in the division image mode will be described.

FIG. 8A illustrates a vertical synchronization signal transmitted from the contents reproduction device 10 and one interval of the vertical synchronization signal indicates one frame. In addition, in the division image mode, as illustrated in FIG. 8B, the image of one division position repeatedly receives 5 frames and division image from a division position 1 to a division position 12 is received over 60 frame periods. The period in which the division image is transmitted becomes a mode in which the memory 38 is written as illustrated in FIG. 8C and a period in which the division image is not transmitted becomes a reading mode.

In addition, as illustrated in FIG. 8D, a write flag which enables the write onto the memory 38 is erected in approximately 2 frame periods while the repetitive transmission is performed over 5 frames of the image of each division position and the write process is performed in the definition conversion unit 37.

FIG. 8E illustrates an image display state in the projector device 30. As illustrated in FIG. 8E, the division image input period over 60 frame periods performs the image mute process and if the division image input is completed, an output preparation of the synthesis image is performed over the number of frame period. In addition, after the output preparation is completed, the output of still image is repeatedly performed for each frame until the output becomes next division image input period.

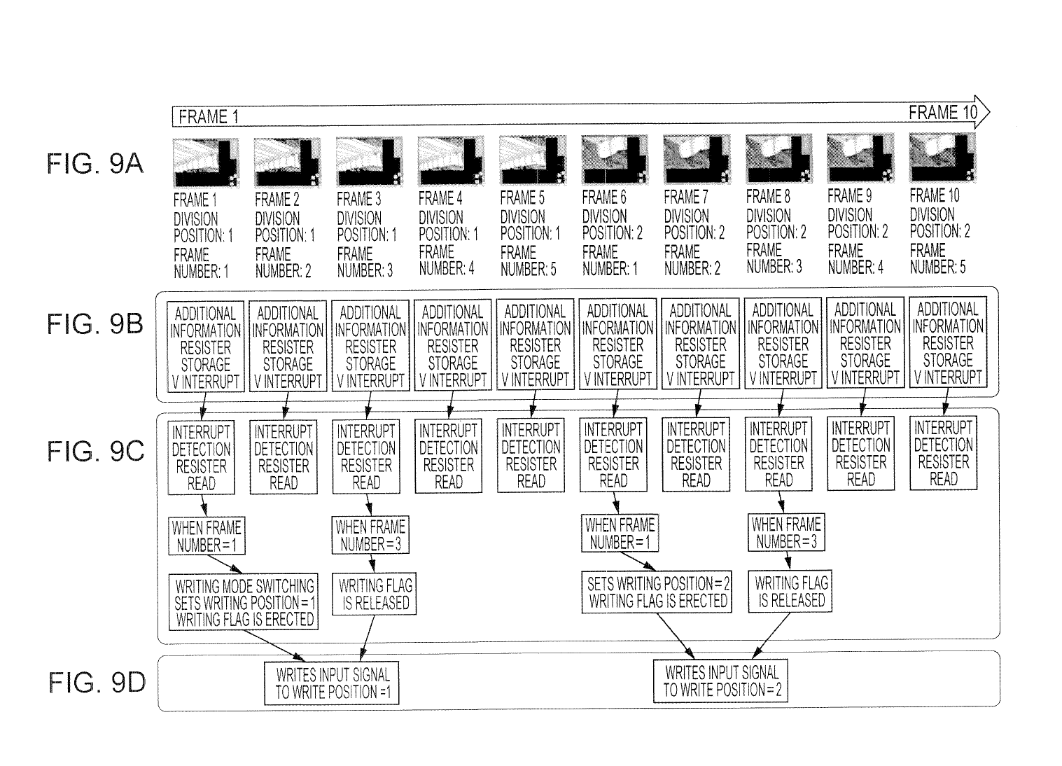

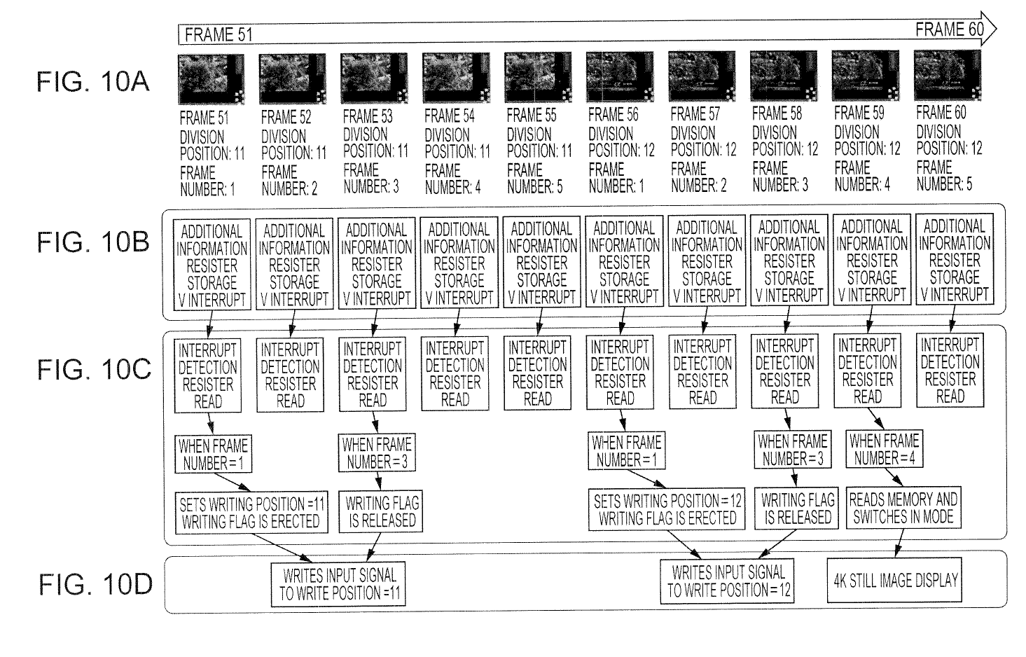

FIGS. 9 and 10 are a sequence diagram illustrating the detail of the operation in the projector device 30 in the division image mode. FIGS. 9A to 9D illustrate an initial 10 frame periods in the division image transmission period of 60 frame periods and FIGS. 10A to 10D illustrates the last 10 frame periods.

As illustrated in FIG. 9A, the input image becomes the image of the same division position for each 5 frame. Herein, as illustrated in FIG. 95, in the additional information detection unit 36, the detected first additional information D1 is stored in a resister in which the mode determination unit 34 is provided.

The first additional information D1 stored in the resister is read for each frame by the control unit 41 as illustrated in FIG. 9C. For example, when the control unit 41 detects the frame number 1 of the division position 1 in a first frame, the memory 38 is changed from the reading mode to the writing mode, the writing position to the memory 38 is set as the division position 1 and the writing flag is erected.

When the write flag is erected, the definition conversion unit 37 performs the process writing the division image of the division position 1 transmitted repeatedly into the memory 38 as illustrated in FIG. 9D. In such an example, the write of the division image of the division position 1 onto the memory 38 is completed when the transmission of the image of at least two second frame is completed.

In addition, when the transmission of the image of 3rd frame is started and when the frame number 3 is detected by the control unit 41, the write flag of the memory 38 is released and the write is completed by the definition conversion unit 37.

In the control unit 41, a process in which the write flag is erected and a process in which the write flag is released are performed in a first frame and a third frame and each division image is written onto the memory 38.

In addition, as illustrated in FIG. 10, the process in which erects the write flag is performed in the frame number 1 (56th frame) of division image of the division position 12 by the control unit 41. In addition, a process which releases the write flag is performed in the frame number 3 (58th frame) of the division image of the division position 12 by the control unit 41. Accordingly, 12 division images are written in the memory 38.

When the whole of the 12 division images are stored in the whole memory 38, a processing switching the mode of the memory 38 from the writing mode to the reading mode is performed by the control unit 41 in a next frame number 4 (59th frame). When the switching process is completed, the display of the still image of the 4K format in which the division image written into the memory 38 is composited is started.

As described above, in the contents reproduction device 10 and the projector device 30, it is possible to transmit the still image of the 4K format exceeding the number of the pixels defined in the HD format by connecting the data in order to transmit the image data of the HD format. In addition, in the projector device 30, it is possible to display the still image of the 4K format at a definition as it is. Therefore, the still image in which the number of pixels of one frame such as the 4K format is numerous is efficiently transmitted using the transmission channel which can not transmit only the image data of the number of pixels limited thereby. The transmitting unit of the contents reproduction device 10 side and the receiving unit of the projector device 30 side can use the existing HD format handling the image data of the HD format and a complicated and a high price configuration corresponding to the 4 k format is not desired.

The still image displayed in the projector device 30 automatically is gradually changed and a slide show display of the high definition image is possible by gradually transmitting a different still image from the contents reproduction device 10.

### 7. Modification Example

In addition, the number of the pixels of one frame and the number of the division described in the example of the above-mentioned embodiment are a preferred example and may be a different numerical value. The position which disposes the division image and the additional information in one frame also is one example and a configuration disposing the division image and the additional information in other position in one frame is preferable.

In addition, in an example of the embodiment described above, though one division image is repeatedly transmitted to five frame periods, a period in which the same division image is repeated may be a plurality of different frame period. Though time necessary for synthesizing and handling the division image is ensured as illustrated in FIGS. 9A to 9D by repeating a plurality of frame period, it is preferable that the repetition period has the number of repetitions less than the example in FIGS. 9A to 9D such as four frame periods or three frame periods.

In addition, an example of an embodiment described above applied to the projector device which projects the images to a screen is described as a display device, but the example of the embodiment may be applied to a display device of a type which a viewer directly views a display panel. Even in a device of transmitting side, the example of the embodiment may be applied to various image devices other than the contents reproduction device illustrated in FIG. 2.

In addition, a configuration which processes the image data in the contents reproduction device illustrated in FIG. 2 or a configuration which processes the image data in the projector device illustrated in FIG. 3 also is an example and in a case where a configuration in which the same image data is transmitted, a sequence in which the processing is performed may be different.

In addition, a transmitting configuration using the transmission channel of the HDMI standard described in an example of the embodiment described above also is an example and a configuration using a transmission channel of the different transmission standard is preferable. In this case, in addition to a configuration transmitting using a wire cable, a configuration using a wireless cable transmitting also may be applied.

Instead of providing each device in the processing unit illustrated in FIGS. 2 and 3, a program which executes a division process in a transmitting side or a synthesis processing in a receiving side is produced and the program is mounted in the information processing device such as a computer, so that the same device may be realized.

In addition, the present disclosure may have following configurations.

(1) A display device including a receiving unit that receives image data of a predetermined format for each frame; an additional information detection unit that detects an additional information disposed in a specific position of the image data of one frame received by the receiving unit; a synthesis unit that extracts division images of a still image disposed in the image data of one frame received by the receiving unit, synthesizes the extracted division images based on the additional information and assembles the still image greater than the number of pixels of the image data of one frame; and a display unit that displays the still image synthesized by the synthesis unit.

(2) The display device according to (1), wherein the image data received by the receiving unit is image data in which the same division images of the still image is repeatedly received in a plurality of frames, and the additional information detected by the addition information detection unit includes information indicating the number of repetitive transmissions of the division images of the still image.

(3) The display device according to (1) or (2), wherein the synthesis unit includes a memory that synthesizes the division images, and writing division images of one dividing area to the memory in the synthesis unit is completed within a period during which the same division images of the still images are repeatedly received in a plurality of frames.

(4) The display device according to any one of (1) to

(3), wherein the display unit does not display the image while the synthesis unit synthesizes the still image and the display unit displays the synthesized still image for each frame after the synthesis of the still image is completed in the synthesis unit.

(5) The display device according to any one of (1) to

(4), further including a mode determination units that determines a transmission mode of the received image data based on the additional information disposed in a specific position of the image data of one frame received by the receiving unit, and wherein when the transmission mode determined by the mode determination unit is a transmission mode transmitting the division images of the still image, the synthesis unit performs the synthesis of the still image and the display unit displays the synthesized still image.

(6) The display device according to (5), wherein the mode determination unit determines information of bits limited within information of a plurality of bits for indicating the transmission mode included in the additional information disposed in the specific position.

(7) The display device according to (5) or (6), wherein a bit position determined by the mode determination unit is set as a position varied for each frame.

(8) The display device according to (5) or (6), further including an image quality processing unit that performs an image quality processing of the image data received by the receiving unit, and wherein when the transmission mode determined by the mode determination unit is a transmission mode transmitting the division images of the still image, the image quality process in the image quality processing unit is stopped.

(9) A display method including: receiving image data of a predetermined format for each frame; detecting an additional information disposed in a specific position of the image data of one frame received in the receiving of the image data; extracting division image of a still image disposed in the image data of one frame received in the receiving of the image data, synthesizing the extracted division images based on the additional information and assembling the still image greater than the number of pixels of the image data of one frame; and displaying the still image synthesized in extracting of the division images.

(10) A transmitting device including a division processing unit that obtains data of a plurality of division images by dividing the image data of one still image for each predetermined area and disposing each of the obtained data of the plurality of division images in image data of a predetermined format having the number of pixels less than that of the still image; an information addition unit that disposes additional information on division images in a specific position within the image data of the predetermined format obtained in the division processing unit; and a transmitting unit that outputs whole produced frames while the additional information unit repeatedly outputs frames in which the additional information is disposed multiple times for each division image.

(11) A transmitting method including: obtaining data of a plurality of division images by dividing the image data of one still image for each predetermined area and disposing each of the obtained data of the plurality of division images in image data of a predetermined format having the number of pixels less than that of the still image; disposing additional information on division images in a specific position within the image data of the predetermined format obtained in the division and processing the image data; and outputting whole produced frames while repeatedly outputting frames in which the additional information is disposed multiple times for each division image in the disposing.

The present disclosure contains subject matter related to that disclosed in Japanese Priority Patent Application JP 2011-273665 filed in the Japan Patent Office on Dec. 14, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a receiving unit that receives image data of a predetermined format for each frame;
an additional information detection unit that detects additional information disposed in a specific position of the image data of one frame received by the receiving unit;
a synthesis unit that extracts division images of a still image disposed in the image data of one frame received by the receiving unit, synthesizes the extracted division images based on the additional information and assembles the still image greater than the number of pixels of the image data of one frame; and
a display unit that displays the still image synthesized by the synthesis unit.

2. The display according to claim 1, wherein the image data received by the receiving unit is image data in which the same division images of the still image is repeatedly received in a plurality of frames, and
the additional information detected by the addition information detection unit includes information indicating the number of repetitive transmissions of the division images of the still image.

3. The display according to claim 2, wherein the synthesis unit includes a memory that synthesizes the division images, and
writing the division images of one dividing area to the memory in the synthesis unit is completed within a period during which the same division images of the still images are repeatedly received in a plurality of frames.

4. The display device according to claim 1, wherein the display unit does not display the image while the synthesis unit synthesizes the still image and the display unit displays the synthesized still image for each frame after the synthesis of the still image is completed in the synthesis unit

5. The display device according to claim 1, further comprising:
a mode determination unit that determines a transmission mode of the received image data based on the additional information disposed in a specific position of the image data of one frame received by the receiving units, and
wherein when the transmission mode determined by the mode determination unit is a transmission mode transmitting the division images of the still image, the synthesis unit performs the synthesis of the still image and the display unit displays the synthesized still image.

6. The display device according to claim 5, wherein the mode determination unit determines information of bits limited within information of a plurality of bits for indicating the transmission mode included in the additional information disposed in the specific position.

7. The display device according to claim 6, wherein a bit position determined by the mode determination unit is set as a position varied for each frame.

8. The display device according to claim 6, further comprising:
an image quality processing unit that performs an image quality processing of the image data received by the receiving unit, and
wherein when the transmission mode determined by the mode determination unit is a transmission mode transmitting the division images of the still image, the image quality process in the image quality processing unit is stopped.

9. A display method comprising:
receiving image data of a predetermined format for each frame;
detecting an additional information disposed in a specific position of the image data of one frame received in the receiving of the image data;
extracting division image of a still image disposed in the image data of one frame received in the receiving of the image data, synthesizing the extracted division images based on the additional information and assembling the still image greater than the number of pixels of the image data of one frame; and
displaying the still image synthesized in the extracting of the division images.

10. A transmitting device comprising:
a division processing unit that obtains data of a plurality of division images by dividing the image data of one still image for each predetermined area and disposing each of the obtained data of the plurality of division images in image data of a predetermined format having the number of pixels less than that of the still image;
an information addition unit that disposes additional information on division images in a specific position within the image data of the predetermined format obtained in the division processing unit; and
a transmitting unit that outputs whole produced frames while the additional information unit outputs repeatedly frames in which the additional information is disposed multiple times for each division image.

11. A transmitting method comprising:
obtaining data of a plurality of division images by dividing the image data of one still image for each predetermined area and disposing each of the obtained data of the plurality of division images in image data of a predetermined format having the number of pixels less than that of the still image;
disposing additional information on division images in a specific position within the image data of the predetermined format obtained in the obtaining; and
outputting whole produced frames while repeatedly outputting frames in which the additional information is disposed multiple times for each division image in the disposing.
